(19) United States
(12) Patent Application Publication
(10) Pub. No.: US 2008/0049969 A1
(43) Pub. Date: Feb. 28, 2008

(54) Methods And Systems For Generating A Symbol Identification Challenge For An Automated Agent

(76) Inventor: Jason David Koziol, Naperville, IL (US)

Correspondence Address: MANISHA CHAKRABARTI, 3108 S. RT. 59, STE. 124-282, NAPERVILLE, IL, 60564, US

(21) Appl. No.: 11/612,470

(22) Filed: Dec. 18, 2006

Related U.S. Application Data
(63) Continuation-in-part of application No. 11/467,218, filed on Aug. 25, 2006.

(51) Int. Cl. G06K 9/00

(52) U.S. Cl. 382/100; 382/187

(57) ABSTRACT

Methods, systems and machine readable medium storing a machine readable program for generating a representation of a symbol that presents an identification challenge for an automated agent are disclosed. A symbol is provided at a first system. A first version of the symbol is defined at the first system. A second version of the symbol is defined at the first system by adding a noise component to the first version of the symbol whereby first and second views of the second version of the symbol in a viewing plane are associated with first and second selectable view options, respectively. The first view of the second version of the symbol is substantially similar to the first version of the symbol and different from the second view of the second version of the symbol.

### CROSS REFERENCE TO RELATED APPLICATION

The present application is a continuation in part of U.S. patent application Ser. No. 11/467,218 filed on Aug. 25, 2006.

### FIELD OF THE INVENTION

The present invention generally relates to data security and more particularly to methods and systems for generating a representation of a symbol that presents an identification challenge for an automated agent.

### BACKGROUND OF THE INVENTION

Sensitive data, such as for example, email addresses, phone numbers, residence addresses, usernames, user passwords, and/or credit card numbers are routinely stored on computer systems. Individuals often use personal computers to store address books containing personal data associated with different individuals. Web servers frequently store personal data associated with different groups, such as for example, clients and customers. In many cases, such computer systems are communicatively coupled to the Internet. Files including sensitive data are also routinely exchanged between different computer systems via the Internet.

Connectivity to the Internet often exposes computers systems to malicious autonomous software applications or automated agents. Automated agents are typically generated by autonomous software applications that operate as an agent for a user or a program. Real and/or virtual machines are used to generate automated agents that simulate human user activity and/or behavior to search for and gain illegal access to computer systems connected to the Internet, retrieve data from the computer systems, and generate databases of culled data for unauthorized use of the data by illegitimate users.

Automated agents typically consist of one or more sequenced operations. The sequence of operations can be executed by a real or virtual machine processor to enact the combined intent of one or more developers and/or deployers of the sequence of operations. The size of the sequence of operations associated with an automated agent can range from a single machine coded instruction to a distributed operating system running simultaneously on multiple virtual processing units. An automated agent may consist of singular agents, independent agents, an integrated system of agents, and agents composed of sub-agents where the sub-agents themselves are individual automated agents. Examples of such automated agents include, but are not limited to, viruses, Trojans, worms, bots, spiders, and crawlers.

The increased use of computer systems that are communicatively coupled to the Internet to store and manipulate different forms of sensitive data has generated a need to format sensitive data into a form that is recognizable to a human user while posing an identification challenge to an automated agent. Storing and/or transmitting sensitive data in such a format enables human users to access the data for legitimate reasons while making it a challenge for automated agents to access the data for illegitimate reasons.

In some prior art systems, static images of sensitive data are represented in a format that includes one or more different noise components. For example, noise components in the form of various types of deformations and/or distortations are introduced into the static image representation of the sensitive data. For example, in a CAPTCHA (Completely Automated Public Turing Test To Tell Computers And Humans Apart) representation of data, noise is deliberately and/or strategically integrated into the static image representation of the sensitive data in an attempt to protect the sensitive data from automated agents that may gain unauthorized access to the data. Unfortunately, continuous advances in optical character recognition technologies have operated to defeat many of the different static image CAPTCHA representations of sensitive data.

Thus what is needed is a method and system for generating a representation of a symbol that presents an identification challenge for an automated agent that seeks to overcome one or more of the challenges and/or obstacles described above.

### SUMMARY OF THE INVENTION

One aspect of the invention provides a method of generating a representation of a symbol that presents an identification challenge for an automated agent. A symbol is provided at a first system. A first version of the symbol is defined at the first system. A second version of the symbol is defined at the first system by adding a noise component to the first version of the symbol whereby first and second views of the second version of the symbol in a viewing plane are associated with first and second selectable view options, respectively. The first view is substantially similar to the first version of the symbol and is different from the second view.

Another aspect of the invention provides a machine readable medium storing a machine executable program for generating a representation of a symbol that presents an identification challenge for an automated agent. The machine readable medium includes machine readable code for providing a symbol at a first system, machine readable code for defining a first version of the symbol at the first system, and machine readable code for defining a second version of the symbol at the first system by adding a noise component to the first version of the symbol whereby first and second views of the second version of the symbol in a viewing plane are associated with first and second selectable view options, respectively, the first view being substantially similar to the first version of the symbol and different from the second view.

Another aspect of the invention provides a system for generating a representation of a symbol that presents an identification challenge for an automated agent. The system includes means for providing a symbol at a first system, means for defining a first version of the symbol at the first system, and means for defining a second version of the symbol at the first system by adding a noise component to the first version of the symbol whereby first and second views of the second version of the symbol in a viewing plane are associated with first and second selectable view options, respectively, the first view being substantially similar to the first version of the symbol and different from the second view.

The foregoing and other features of the invention will become further apparent from the following detailed description of the presently preferred embodiments read in conjunction with the accompanying drawings. The detailed description and drawings are merely illustrative of the invention rather than limiting the scope of the invention being defined by the appended claims and equivalents thereof.

### BRIEF DESCRIPTION OF THE DRAWINGS

The present invention is illustrated by way of example and not limited in scope to the accompanying figures, in which like reference numerals indicate similar elements, and in which:

FIG. 1 is a block diagram of a system that may be used to implement one embodiment of generating a representation of a symbol that presents an identification challenge for an automated agent in accordance with the principles of the present invention;

FIG. 2 is a block diagram of one embodiment of a challenge symbol generator for generating a representation of a symbol that presents an identification challenge for an automated agent in accordance with the principles of the present invention;

FIG. 3 is an example of a symbol image having a block font format generated by one embodiment of a symbol image generation module for a symbol “1” in accordance with the principles of the present invention;

FIG. 4 is an example of a symbol image having a three dimensional block font format generated by one embodiment of a symbol image generation module for a symbol “1” in accordance with the principles of the present invention;

FIG. 5 is an example of a distorted symbol image generated by one embodiment of a symbol image generation module for a symbol “1” in accordance with the principles of the present invention;

FIG. 6 is an example of another distorted symbol image generated by one embodiment of a symbol image generation module for a symbol “1” in accordance with the principles of the present invention;

FIG. 7 is an example of a rendering of an original version of the symbol associated with the symbol image of FIG. 3 in the symbol coordinate system in accordance with the principles of the present invention;

FIG. 8 is an example of a table including a plurality of vectors that have been generated by one embodiment of the original symbol definition module to define the original version of the symbol associated with the symbol image of FIG. 3 in the symbol coordinate system in accordance with the principles of the present invention;

FIG. 9 is an example of a table including a plurality of vectors generated by one embodiment of the dynamic symbol definition module to define a dynamic version of the symbol associated with the original version of the symbol of FIG. 8 in the symbol coordinate system in accordance with the principles of the present invention;

FIG. 10(a)-(g) depicts illustrative examples of a series of different views of a rendering of the original version of the symbol defined in FIG. 8 in a viewing plane as the symbol coordinate system is rotated about the y-axis in accordance with the principles of the invention;

FIG. 11(a)-(g) depicts illustrative examples of a series of different symbol views of a rendering of the dynamic version of the symbol defined in FIG. 9 in a viewing plane as the symbol coordinate system is rotated about the y-axis in accordance with the principles of the present invention;

FIG. 12 is an example of a table including a plurality of vectors that have been generated by one embodiment of the dynamic symbol generation module to include a false symbol image as a symbol view in the dynamic version of the symbol of FIG. 9 in accordance with the principles of the present invention;

FIG. 13 is an example of a rendering of the false symbol image of the dynamic version of the symbol of FIG. 12 in accordance with the principles of the present invention;

FIG. 14 is an example of a table including a plurality of vectors generated by one embodiment of the dynamic symbol definition module to define a dynamic representation of the false symbol image of FIG. 12 in accordance with the principles of the present invention;

FIG. 15(a)-(e) depicts illustrative examples of a series of different symbol views of a rendering of the dynamic version of the symbol as defined by both FIG. 9 and FIG. 14 in a viewing plane as the symbol coordinate system is rotated about the y-axis in accordance with the principles of the present invention;

FIG. 16 is a flowchart of one embodiment of a method of generating a representation of a symbol that presents a challenge for an automated agent in accordance with the principles of the present invention;

FIG. 17 is a flowchart of another embodiment of a method of generating a representation of a symbol that presents a challenge for an automated agent in accordance with the principles of the present invention; and

FIG. 18 is a block diagram of another system that may be used to implement one embodiment of generating a representation of a symbol that presents an identification challenge for an automated agent in accordance with the principles of the present invention.

### DETAILED DESCRIPTION OF THE PREFERRED EMBODIMENTS

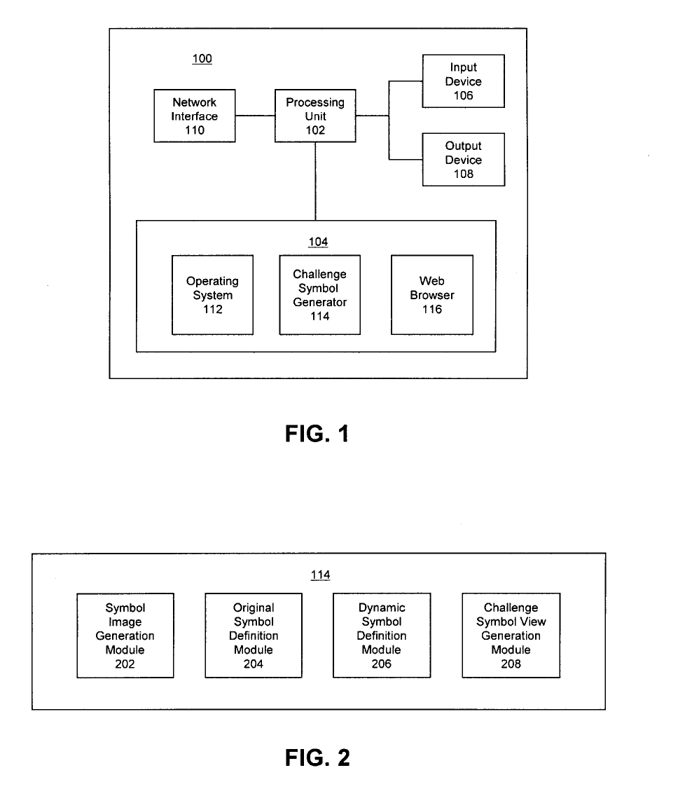

Referring to FIG. 1, a block diagram of a system 100 that may be used to implement one embodiment of generating a representation of a symbol that presents an identification challenge for an automated agent in accordance with the principles of the present invention is shown. Examples of devices that may incorporate the system 100 include, but are not limited to, personal computers, personal device assistants, and cellular telephones. In one embodiment, the system 100 generally includes a processing unit 102 communicatively coupled to a memory 104, one or more input devices 106, one or more output devices 108, and a network interface 110.

The processing unit 102 generally includes a processor or controller. In one embodiment, the memory 104 includes one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, and flash memory devices. Examples of input devices 106 include, but are not limited to, a keyboard, a scanner, and a mouse. Examples of output devices 108 include, but are not limited to, a display device and a printer. In one embodiment, the processing unit 102 is communicatively coupled to a touch-sensitive display device. The touch-sensitive display device operates as both an input device 106 and an output device 108. In one embodiment, the network interface 110 is an Internet interface port. In one embodiment, the system 100 can be communicatively coupled to another computing device via the network interface 110.

In one embodiment, the memory 104 generally includes an operating system 112 and a challenge symbol generator 114. Examples of operating systems that may be used include, but are not limited to, versions of Microsoft Windows® operating systems, versions of Java virtual machines, versions of Linux, versions of Apple Machintosh® operating systems, different types of embedded operating systems (such as for example Palm OS®), mainframe operating systems (such as for example Unix®), and proprietary operating systems (such as for example, IRIX). Additional examples of operating systems include distributed virtual operating systems that can be deployed using a wire protocol (such as for example TCP/IP), a message protocol (such as for example HTTP), any number of formatting standards (such as for example HTTP and SVG), and scripting languages (such as for example Javascript).

In one embodiment, the memory includes a web browser 116. Examples of web browsers 116 that may be used include, but are not limited to, Firefox® and Internet Explorer®. In alternative embodiments, the memory 104 may include additional application modules that facilitate the operation of the system 100. The processing unit 102 generally retrieves and executes machine readable instructions or software programs that are stored in the memory 104.

Referring to FIG. 2 a block diagram of one embodiment of a challenge symbol generator 114 for generating a representation of a symbol that presents an identification challenge for an automated agent in accordance with the principles of the present invention is shown. The challenge symbol generator 114 generally includes a symbol image generation module 202, an original symbol definition module 204, a dynamic symbol definition module 206, and a challenge symbol view generation module 208. In one embodiment, the symbol image generation module 202, the original symbol definition module 204, the dynamic symbol definition module 206, and the challenge symbol view generation module 208 are all included within a single device. In another embodiment, the symbol image generation module 202, the original symbol definition module 204, the dynamic symbol definition module 206, and the challenge symbol view generation module 208 are distributed over one or more communicatively coupled devices.

Symbol data representative of a symbol is received at the symbol image generation module 202. In one embodiment, the symbol data is received at the system 100 via an input device 106. In one embodiment, the symbol data is received at the system 100 via the network interface 110. In one embodiment, a symbol consists of one or more alphanumeric characters. In one embodiment, the symbol data consists of an ASCII representation of the one or more alphanumeric characters. In one embodiment, the symbol data consists of an image representation of the one or more alphanumeric characters.

In one embodiment, the symbol consists of one or more non-alphanumeric images, such as for example, icons, directional arrows, descriptive directions, descriptive problems, and/or company logos. Examples of icons include, but are not limited to, a happy face, star, stop sign, traffic light, speaker, eye, magnifying glass, lightning bolt, heart, checkmark, no (red circle with a line through it). Examples of directional arrows include, but are not limited to, sequence of left, right, up, down, circular, back and forth, button clicks, and compass point directions. An example of descriptive direction is “click on plaid square.” And example of a descriptive problem is “what is two plus two?”

The symbol is represented using symbol data representations in, such as for example, including, but not limited to, BMP (Windows Bitmap®), GIF (Compuserve Graphical Image Format), PNG (Portable Network graphics), SVG (Scalable Vector Graphics), VRML (Virtual Reality Markup Language), WMF (Windows MetaFile®), AVI (Audio Visual Interleave), MOV (Quicktime Movie), SWF (Shockwave Flash), DirectX, OpenGL, Java, Windows®, MacOS®, Linux, PDF (portable document format), JPEG (Joint Photographic Experts Group), or MPEG (Moving Picture Experts Group).

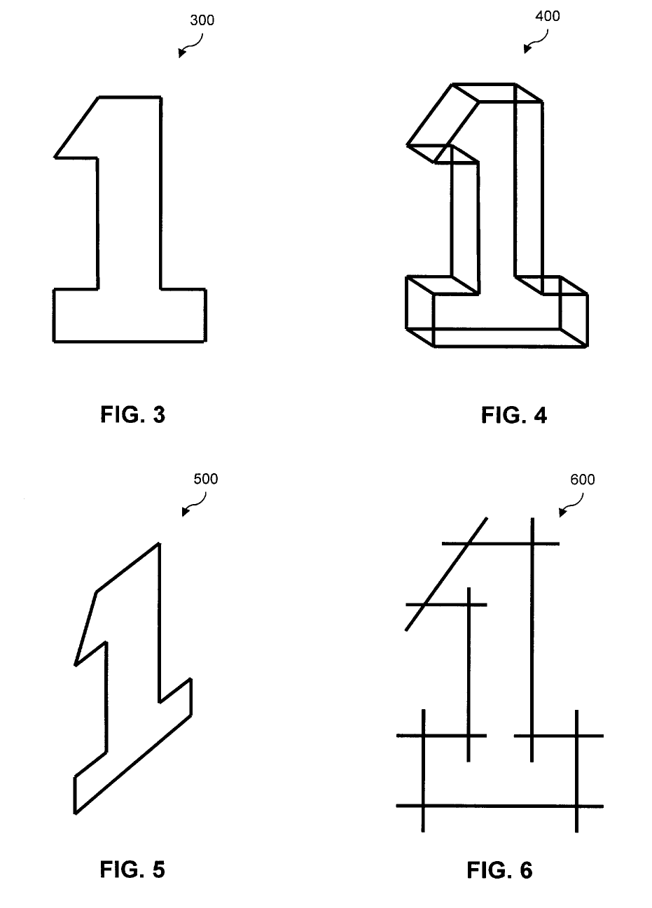

The symbol image generation module 202 generates a symbol image of the symbol associated with the received symbol data. In one embodiment, the symbol image is recognizable to both a human user and an automated agent. Referring to FIG. 3, an example of a symbol image 300 having a block font format generated by one embodiment of a symbol image generation module 202 for a symbol “1” in accordance with the principles of the present invention is shown. Referring to FIG. 4, an example of a symbol image 400 having a three dimensional block font format generated by one embodiment of a symbol image generation module 202 for a symbol “1” in accordance with the principles of the present invention is shown. It should be noted that while a number of examples of different formats for symbol images have been described, alternative formats for symbol images are also considered to be within the scope of the invention. In one embodiment, the symbol image generation module 202 provides a user with the option of selecting one of a number of different available formats for generated a symbol image.

In one embodiment, the symbol image is a distorted symbol image where the distorted symbol image poses a symbol identification challenge for an automated agent. Referring to FIG. 5, an example of a distorted symbol image 500 generated by one embodiment of a symbol image generation module 202 for a symbol “1” in accordance with the principles of the present invention is shown. Referring to FIG. 6, an example of another distorted symbol image 600 generated by one embodiment of a symbol image generation module 202 for a symbol “1” in accordance with the principles of the present invention is shown. In one embodiment, the distorted symbol image is a warped representation of the symbol. In one embodiment, the distorted symbol image includes one or more randomly generated arcs strategically positioned with respect to the symbol. In one embodiment, the distorted symbol image includes the symbol with background noise, such as for example including, but not limited to, lines, grids, circles, and dots. In one embodiment, the distorted symbol image is a handwritten representation of the symbol. In one embodiment, the symbol image is a representation of the symbol created using variable stroke widths. In one embodiment, the distorted symbol image is a representation of the symbol including randomly stretched and/or compressed sections of the symbol. It should be noted that while a number of different types distorted symbol images have been described for representing a symbol, alternative types of distorted symbol images are also considered to be within the scope of the invention. In one embodiment, the symbol image generation module 202 provides a user with the option of selecting one of a number of different available distorted symbol images for generating a symbol image.

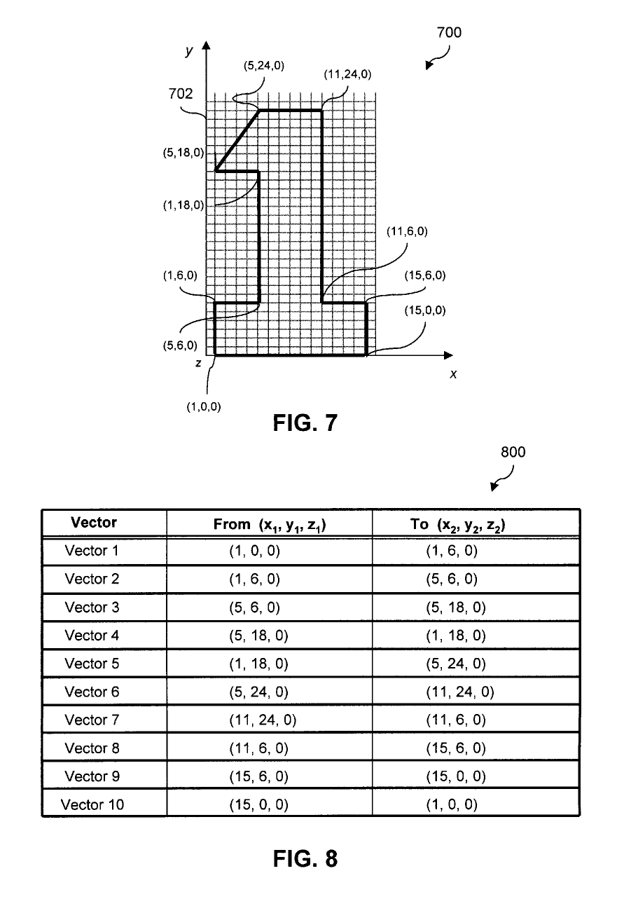

Referring back to FIG. 2, the symbol image generated by the symbol image generation module 202 is received at the original symbol definition module 204. In one embodiment, a three dimensional symbol coordinate system is defined by x, y, and z axes. The original symbol definition module 204 defines the received symbol image in the x-y plane of the symbol coordinate system. The symbol image as defined by the original symbol definition module 204 in the symbol coordinate system is the original version of the symbol. Referring to FIG. 7, an example of a rendering of an original version of the symbol 700 associated with the symbol image 300 of FIG. 3 in the symbol coordinate system 702 in accordance with the principles of the present invention is shown. Referring to FIG. 8, an example of a table 800 including a plurality of vectors that have been generated by one embodiment of the original symbol definition module 204 to define the original version of the symbol associated with the symbol image 300 of FIG. 3 in the symbol coordinate system 702 in accordance with the principles of the present invention is shown. It should be noted that while one type of symbol coordinate system has been described for defining an original version of a symbol associated with a symbol image, other types of symbol coordinate systems and/or alternative symbol definition mechanisms may be used to define an original version of a symbol without departing from the spirit of the invention.

Referring back to FIG. 2, the dynamic symbol definition module 206 receives the original version of the symbol as an input and incorporates a noise component into the original version of the symbol thereby defining a dynamic version of the symbol. The dynamic symbol definition module 206 selects a plurality of points from the original version of the symbol defined in the x-y plane of the symbol coordinate system and adds a z-axis noise offset to each of the plurality of selected points thereby generating a dynamic version of the symbol. In one embodiment, the dynamic symbol definition module 206 selects the endpoints of each of the plurality of vectors that define the original version of the symbol as the selected plurality of points. In one embodiment, in cases, where a single point is shared as an endpoint by a first vector and a second vector, a first z-axis noise offset is added to the shared point as a component of the first vector and a second z-axis noise offset is added to the shared point as a component of the second vector. In one embodiment, the dynamic symbol definition module 206 randomly selects a plurality of points from the original version of the symbol. In one embodiment, the dynamic symbol definition module 206 selects a pre-defined number of points from the original version of the symbol as the plurality of points. In one embodiment, each of the z-axis noise offsets that are added to each of the selected plurality of points are randomly generated z-axis noise offset values. In one embodiment, each of the individual z-axis noise offset values is a different z-axis noise offset value. In one embodiment, the z-axis noise offset values are selected from a pre-defined range of z-axis noise offset values.

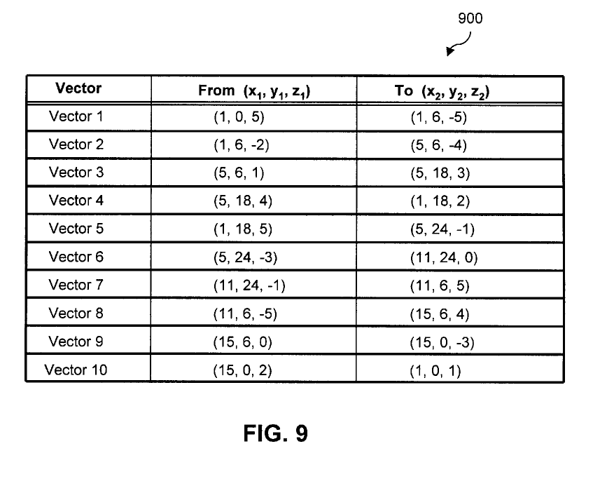

Referring to FIG. 9, an example of a table 900 including a plurality of vectors generated by one embodiment of the dynamic symbol definition module 206 to define a dynamic version of the symbol associated with the original version of the symbol of FIG. 8 in the symbol coordinate system 702 in accordance with the principles of the present invention is shown. The dynamic symbol definition module 206 selected the endpoints of each of the plurality of vectors used to define the original version of the symbol as the selected plurality of points. The dynamic symbol definition module 206 added randomly generated z-axis noise offsets to each of the plurality of endpoints of the vectors defining the original version of the symbol to generate the dynamic version of the symbol. It should be noted that while one type of symbol coordinate system has been described for defining a dynamic version of a symbol associated with a symbol image, other types of symbol coordinate systems and/or alternative symbol definition mechanisms may be used to define a dynamic version of a symbol without departing from the spirit of the invention.

Referring back to FIG. 2, the challenge symbol view generation module 208 receives the dynamic version of the symbol as an input and generates a challenge symbol view that poses a symbol identification challenge for an automated agent. A viewing plane is generally parallel to the x-y plane of an initial orientation position of the symbol coordinate system. A symbol view is an orthogonal projection of a representation of the dynamic version of the symbol in the symbol coordinate system onto the viewing plane. The symbol view generally varies as a function of the orientation of the symbol coordinate system with respect to the viewing plane. The orthogonal projection of the representation of the dynamic version of the symbol in the symbol coordinate system, with the symbol coordinate system being in the initial orientation position, projects the original symbol view onto the viewing plane. The original symbol view is substantially similar to the symbol image generated by the symbol image generation module 202.

In one embodiment, the challenge symbol view generation module 208 rotates the symbol coordinate system, containing the dynamic rendering of the symbol, from an initial orientation position through a rotation angle α about the x-axis and a rotation angle β about the y-axis. The symbol view generated as a product of the orthogonal projection of the dynamic rendering of the symbol in the rotated symbol coordinate system onto the viewing plane is a challenge symbol view. A challenge symbol view of the dynamic rendering of the symbol is different from the symbol image generated by the symbol image generation module 202.

Different challenge symbol views can be generated by varying individual values of the rotation angle α and/or the rotation angle β. In one embodiment, the value of the rotation angle α and the value of the rotation angle β are randomly generated values. In one embodiment, the challenge symbol views of the dynamic version of the symbol become increasingly similar to the original symbol view as the values of the rotation angle α and the rotation angle β approach 0°.

In one embodiment, the challenge symbol view generation module 208 rotates the symbol coordinate system, containing a rendering of the dynamic version of the symbol, from an initial orientation position through a rotation angle α about the x-axis. The symbol view generated as a product of the orthogonal projection of the rendering of the dynamic version of the symbol in the rotated symbol coordinate system onto the viewing plane is one of many possible challenge symbol views. A challenge symbol view of the dynamic version of the symbol is different from the symbol image generated by the symbol image generation module 202. Different challenge symbol views can be generated by varying values of the rotation angle α. In one embodiment, the value of the rotation angle α is a randomly generated value.

In one embodiment, the challenge symbol view generation module 208 rotates the symbol coordinate system, containing a rendering of the dynamic version of the symbol, from an initial orientation position through a rotation angle β about the y-axis. The symbol view generated as a product of the orthogonal projection of the rendering of the dynamic version of the symbol in the rotated symbol coordinate system onto the viewing plane is a challenge symbol view. A challenge symbol view of the dynamic version of the symbol is different from the symbol image generated by the symbol image generation module 202. Different challenge symbol views can be generated by varying values of the rotation angle β. In one embodiment, the value of the rotation angle β is a randomly generated value.

In one embodiment, the challenge symbol view generation module 208 selects a particular challenge symbol view of the dynamic version of the symbol for storage in the memory 104 at the system 100. The selected challenge symbol view is a challenge symbol view that is typically substantially different from the original symbol view. The symbol received at the challenge symbol generator 114 is stored as the selected challenge symbol view at the system 100. The selected challenge symbol view of the symbol that is stored at the system 100 poses a symbol identification challenge to an automated agent that may gain access to the system 100.

In one embodiment, the original version of the symbol is discarded. In one embodiment, the symbol data associated with the symbol is discarded. In one embodiment, the symbol image associated with the symbol is discarded. In one embodiment, the original version of the symbol is stored in a storage device that is generally inaccessible to an automated agent. In one embodiment, the symbol data associated with the symbol is stored in a storage device that is generally inaccessible to an automated agent. In one embodiment, the symbol image associated with the symbol is stored in a storage device that is generally inaccessible to an automated agent.

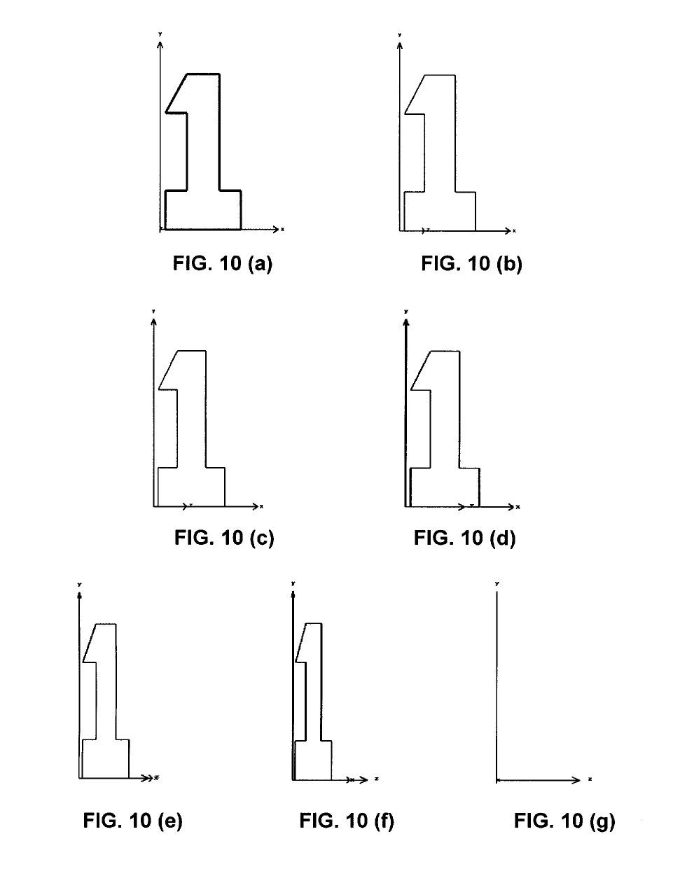

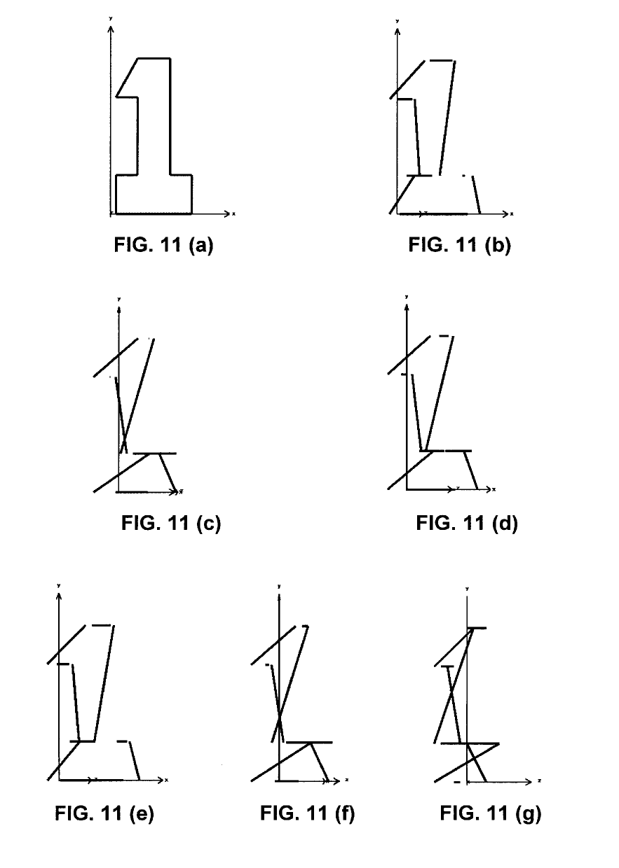

Referring to FIG. 10(a)-(g) illustrative examples of a series of different views of a rendering of the original version of the symbol defined in FIG. 8 in a viewing plane as the symbol coordinate system is rotated about the y-axis in accordance with the principles of the invention is shown. Referring to FIG. 11(a)-(g) illustrative examples of a series of different symbol views of a rendering of the dynamic version of the symbol defined in FIG. 10 in a viewing plane as the symbol coordinate system is rotated about the y-axis in accordance with the principles of the present invention are shown. The series of different views of the original version of the symbol in FIG. 10 (a)-(g) are presented to provide a basis for comparing the different views of the original version of the symbol with parallel symbol views of the dynamic representation of the symbol shown in FIG. 11(a)-(g).

Each of the different views of the original version of the symbol in FIG. 10(a)-(g) and the different symbol views of the dynamic version of the symbol FIG. 11(a)-(g) is associated with different values of the rotation angle β while the rotation angle α is maintained at a value of 0°. The symbol coordinate system 702 is displayed as a part of each of the different views to illustrate the orientation of the symbol coordinate system 702 with respect to the viewing plane. The symbol coordinate system 702 is not displayed in the actual rendering of the symbol views of the dynamic version of the symbol in the viewing plane.

FIG. 10(a) depicts a view of the original version of the symbol where the value of the rotation angle α is 0° and the value of the rotation angle β is 0°. FIG. 11(a) depicts the original symbol view of the dynamic version of the symbol where the value of the rotation angle α is 0° and the value of the rotation angle β is 0°. When the value of the rotation angle α is 0° and the value of the rotation angle β is 0°, the symbol coordinate system 702 is in the initial orientation position with respect to the viewing plane. Note that the symbol view of the dynamic version of the symbol when the symbol is in the initial orientation position in FIG. 11(a) is similar to the original version of the symbol shown in FIG. 10(a).

FIG. 10(b) depicts a view of the original version of the symbol where the value of the rotation angle α is 0° and the value of the rotation angle β is 22.5°. FIG. 11(b) depicts a challenge symbol view of the dynamic version of the symbol where the value of the rotation angle α is 0° and the value of the rotation angle β is 22.5°.

FIG. 10(c) depicts a view of the original version of the symbol where the value of the rotation angle α is 0° and the value of the rotation angle β is 30°. FIG. 11(c) depicts another comparable challenge symbol view of the dynamic version of the symbol where the value of the rotation angle α is 0° and the value of the rotation angle β is 30°.

FIG. 10(d) depicts a view of the original version of the symbol where the value of the rotation angle α is 0° and the value of the rotation angle β is 45°. FIG. 11(d) depicts another challenge symbol view of the dynamic version of the symbol where the value of the rotation angle α is 0° and the value of the rotation angle β is 45°.

FIG. 10(e) depicts a view of the original version of the symbol where the value of the rotation angle α is 0° and the value of the rotation angle β is 60°. FIG. 11(e) depicts another challenge symbol view of the dynamic version of the symbol where the value of the rotation angle α is 0° and the value of the rotation angle β is 60°.

FIG. 10(f) depicts a view of the original version of the symbol where the value of the rotation angle α is 0° and the value of the rotation angle β is 67.5°. FIG. 11(f) depicts another challenge symbol view of the dynamic version of the symbol where the value of the rotation angle α is 0° and the value of the rotation angle β is 67.5°.

FIG. 10(g) depicts a view of the original version of the symbol where the value of the rotation angle α is 0° and the value of the rotation angle β is 90°. FIG. 11(g) depicts another challenge symbol view of the dynamic version of the symbol where the value of the rotation angle α is 0° and the value of the rotation angle β is 90°.

Note that the views of the rotated original version of the symbol in FIG. 10(b)-(f) are relatively more identifiable by an automated agent as the associated symbol, than the challenge symbol views of the rotated dynamic version of the symbol illustrated in FIG. 11(b)-(g). In other words, the challenge symbol views of the symbol illustrated in FIG. 11(b)-(g) pose a symbol identification challenge for an automated agent.

In one embodiment, challenge symbol generator 114 generates a dynamic version of a received symbol that includes a false symbol image as one of the possible challenge symbol views. The challenge symbol generator 114 generates a dynamic version of the symbol received for processing. In one embodiment, the dynamic version of the symbol includes a dynamic version of an original symbol and a dynamic version of a false symbol, where the original symbol is the symbol that is received by the challenge symbol generator 114 for processing.

Symbol data associated with a symbol is received at the symbol image generation module 202. The symbol image generation module 202 generates a symbol image of the symbol. The original symbol definition module 204 defines an original version of the symbol associated with the received symbol image in the x-y plane of a three dimensional symbol coordinate system. The dynamic symbol definition module 206 selects a plurality of points from the original version of the symbol and adds z-axis noise offsets to each of the selected plurality of points thereby generating a dynamic version of the original symbol.

In one embodiment, the dynamic symbol definition module 206 generates a value for a false symbol rotation angle θ_{FS} about the x-axis of the symbol coordinate system and a value for a false symbol rotation angle λ_{FS} about the y-axis of the symbol coordinate system. In one embodiment, the dynamic symbol definition module 206 generates a value for a false symbol rotation angle θ_{FS} about the x-axis of the symbol coordinate system. In one embodiment, the dynamic symbol definition module 206 generates a value for a false symbol rotation angle λ_{FS} about the y-axis of the symbol coordinate system. In one embodiment, the values of one or both of the false symbol rotation angles θ_{FS} and λ_{FS} are randomly generated values. In another embodiment, the values of one or both of the false symbol rotation angles θ_{FS} and λ_{FS} are pre-defined values. When the symbol coordinate system is rotated from the initial orientation position through the false symbol rotation angle(s), the symbol coordinate system is positioned in a false symbol view orientation.

A false symbol image is received at the dynamic symbol definition module 206. In one embodiment, the false symbol image is generated by the dynamic symbol definition module 206. In one embodiment, a false symbol image is selected from a plurality of false symbol images available for selection by a user. In one embodiment, the plurality of pre-defined false symbol images is stored at the system 100 and the dynamic symbol definition module 206 randomly selects one of the pre-defined false symbol images. In one embodiment, the false symbol image is provided by a user via an input device 106.

The dynamic symbol definition module 206 defines the false symbol image in a false symbol definition plane of the symbol coordinate system, such that the defined false symbol image is visible in the viewing plane when a rendering of the dynamic version of the symbol within the symbol coordinate system is projected onto a viewing plane with the symbol coordinate system being positioned in the false symbol view orientation. More specifically, the dynamic symbol definition module 206 rotates the symbol coordinate system about the false symbol rotation angle(s) and defines a plane of the rotated symbol coordinate system that is generally parallel the viewing plane as the false symbol definition plane. The dynamic symbol definition module 206 defines the false symbol image in the false symbol definition plane of the symbol coordinate system.

The dynamic symbol definition module 206 adds a noise component to the false symbol image defined in the false symbol definition plane of the symbol coordinate system thereby defining the dynamic version of the false symbol. In one embodiment, the dynamic symbol definition module 206 selects a plurality of points from the false symbol defined in the false symbol definition plane. In one embodiment, the dynamic symbol definition module 206 selects the endpoints of the vectors that define the false symbol image in the false symbol definition plane as the selected plurality of points. The dynamic symbol definition module 206 adds a noise component to each of the selected plurality of points. In one embodiment, the noise components consist of noise offsets that are added to each of the selected plurality of points in an axis that is generally perpendicular to the false symbol definition plane. In one embodiment, each of the noise offset values is a randomly generated value.

In one embodiment, the dynamic symbol definition module 206 defines the false symbol as having a presentation format that is different from the defined presentation format of the original symbol. In one embodiment, the presentation format for a depiction of the original symbol in the viewing plane is a first color and the presentation format for a depiction of the false symbol in the viewing plane is a second color. In one embodiment, the presentation format for a depiction of the original symbol in the viewing plane is a first font style and the presentation format for a depiction of the false symbol in the viewing plane is a second font style. In one embodiment, the presentation format for a depiction of the original symbol in the viewing plane is using lines having a first thickness and the presentation format for a depiction of the false symbol in the viewing plane is using lines having a second thickness. It should be noted that while a number of different presentation formats for the original symbol and the false symbol having been described, alternative presentation formats that enable a human user to distinguish one of the original and false symbol from the other of the original and false symbol are also considered to be within the scope of the invention.

In one embodiment, the dynamic symbol definition module 206 generates specifications that specify the specific presentation format used to present the original symbol in the viewing plane so that a human user is able to identify the original symbol. In one embodiment, the dynamic symbol definition module 206 generates specifications that specify the specific presentation format used to present the false symbol in the viewing plane so that a human user is able to identify the original symbol. In one embodiment, the dynamic symbol definition module 206 generates specifications that specify the specific presentation formats used to present each of the original symbol in and the false symbol in the viewing plane so that a human user is able to identify the original symbol.

In one embodiment, if the original symbol is associated with a first category of symbols, the false symbol is selected from a second category of symbols. For example, if the original symbol consists of a number, the selected false symbol may be a letter. The dynamic symbol definition module 206 generates specifications that specify the category associated with the original symbol so that a human user is able to distinguish the original symbol from the false symbol.

The dynamic version of the symbol includes both the dynamic version of the original symbol and the dynamic version of the false symbol. When a dynamic version of the symbol is rendered in the symbol coordinate system and the symbol coordinate system is oriented in an initial orientation position, an orthogonal projection of a rendering of the dynamic version of the symbol in the symbol coordinate system generates a view of the original symbol and a noisy view of the false symbol image in the viewing plane. When a dynamic version of the symbol is rendered in the symbol coordinate system and the symbol coordinate system in oriented in the false symbol view orientation, an orthogonal projection of a rendering of the dynamic version of the symbol in the symbol coordinate system generates a view of the false symbol and a noisy view of the original symbol.

As described previously, the challenge symbol view generation module 208 receives the dynamic version of the symbol as an input and generates a challenge symbol view that poses a symbol identification challenge for an automated agent. In one embodiment, the challenge symbol view generation module 208 rotates the symbol coordinate system, containing the dynamic rendering of the symbol, from an initial orientation position through one or both of a rotation angle α about the x-axis and a rotation angle β about the y-axis. The challenge symbol view generated as a product of the orthogonal projection of the dynamic rendering of the symbol in the rotated symbol coordinate system onto the viewing plane is a challenge symbol view. A challenge symbol view of the dynamic rendering of the symbol is different from the symbol image generated by the symbol image generation module 202. In one embodiment, the challenge symbol view generation module 208 includes the original symbol and false symbol specification as a component of a challenge symbol view package. In one embodiment, the challenge symbol view package is stored at the system 100.

The following illustrative example is used to illustrate the manner in which the challenge symbol generator 114 generates a dynamic version of a symbol including a dynamic version of an original symbol and a dynamic version of a false symbol in accordance with the principles of the invention. In this illustrative example, the symbol image generation module 202 generated the symbol image 300 shown in FIG. 3 to represent the symbol “1”. The original symbol definition module 204 generated an original version of the symbol of the received symbol image 300 as previously described with reference to FIG. 7 and FIG. 8. The dynamic symbol definition module 206 added noise components in the form of z-axis noise offsets to the original version of the symbol as previously described with reference to FIG. 9.

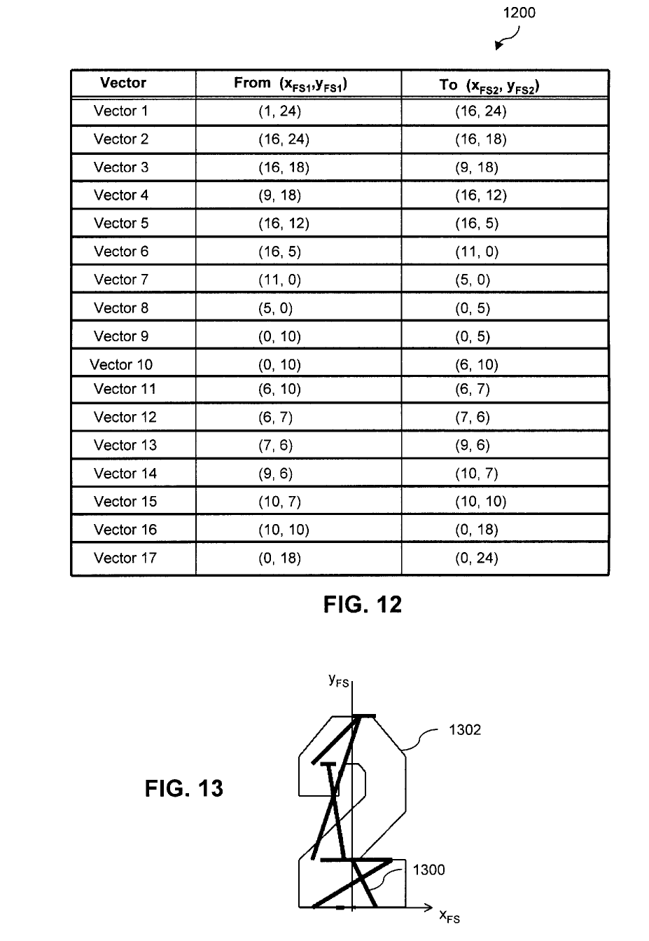

In this example, the dynamic symbol definition module 206 generated a false symbol image for the false symbol “2”, a value of 0° for a false symbol rotation angle θ_{FS} and a value of 90° for a false symbol rotation angle λ_{FS}. The dynamic symbol definition module 206 rotated the symbol coordinate system about the generated false symbol rotation angles θ_{FS} and λ_{FS} and defined a plane in the symbol coordinate system that is generally parallel to the viewing plane as the false symbol definition plane. In this example, the false symbol definition plane is defined by a x_{FS}-axis and a y_{FS}-axis. The dynamic symbol definition module 206 defined the false symbol image in the false symbol definition plane using vectors defined by x_{FS}-y_{FS} coordinates in the false symbol definition plane. Referring to FIG. 12 an example table including a plurality of vectors generated by one embodiment of the dynamic symbol generation module 206 to define the false symbol image in the false symbol definition plane in accordance with the principles of the present invention is shown.

Referring to FIG. 13 an example of an orthogonal projection of a rendering of the dynamic version of the original symbol 1300 and of a rendering of the false symbol 1302 in the false symbol definition plane, as defined in the table of FIG. 12, in the symbol coordinate system onto a viewing plane in accordance with the principles of the present invention is shown. The symbol coordinate system is oriented in the false symbol view orientation in FIG. 13. In this example, the dynamic symbol definition module 206 has used a presentation format that depicts the original symbol in the viewing plane using lines having a first thickness and depicts the false symbol in the viewing plane using lines having a second thickness, where the first thickness is relatively thicker than the second thickness.

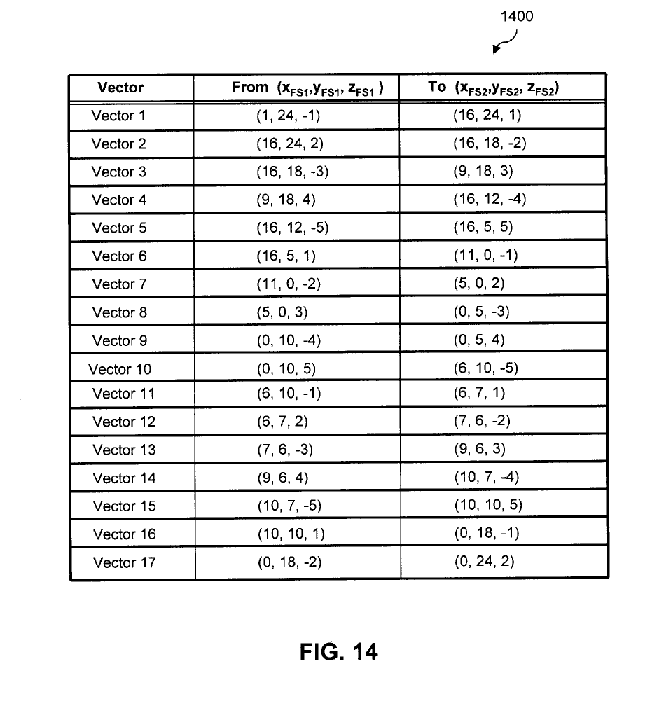

The dynamic symbol definition module 206 selected the endpoints of each of the plurality of vectors that define the false symbol image 1302 in the false symbol definition plane. Noise offset were added to the endpoints of each of the plurality of vectors in an axis that is generally perpendicular to the false symbol definition plane. For the purposes of this illustrative example, the axis generally perpendicular to the false symbol image coordinate system will be referred to as the z_{FS} axis. In other words the dynamic version of the false symbol is defined in a three dimensional false symbol coordinate system defined by the x_{FS}, y_{FS}, and z_{FS} axes. As mentioned previously, the x_{FS}-y_{FS} plane is generally parallel to the viewing plane. Referring to FIG. 14 an example table including the plurality of vectors generated by one embodiment of the dynamic symbol definition module 206 to define the dynamic version of the false symbol image in accordance with the principles of the present invention is shown.

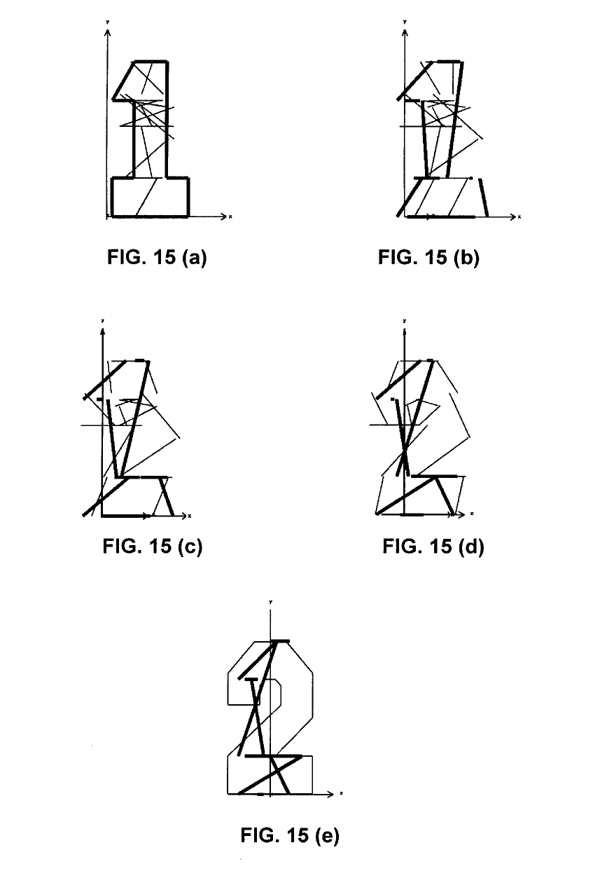

Referring to FIG. 15 (a)-(e) illustrative examples of a series of different symbol views of a rendering of the dynamic version of the symbol as defined by FIG. 9 and FIG. 14 in a viewing plane as the symbol coordinate system is rotated about the y-axis in accordance with the principles of the present invention are shown. The dynamic version of the symbol includes the dynamic version of the original symbol and the dynamic version of the false symbol. Each of the different views of the dynamic version of the symbol in FIG. 15(a)-(e) is associated with different values of the rotation angle β while the rotation angle α is maintained at a value of 0°. The symbol coordinate system is displayed as a part of each of the different views to illustrate the orientation of the symbol coordinate system with respect to the viewing plane. The symbol coordinate system is not displayed in the actual rendering of the symbol views of the dynamic version of the symbol in the viewing plane.

FIG. 15 (a) depicts the original symbol view of the dynamic version of the symbol where the value of the rotation angle α is 0° and the value of the rotation angle β is 0°. The symbol coordinate system is in the initial orientation position when the value of the rotation angle α is 0° and the value of the rotation angle β is 0°. The original symbol view of the dynamic version of the symbol includes a view of the original version of the symbol superimposed on a noisy view of the dynamic version of the false symbol.

FIG. 15 (b) depicts a challenge symbol view of the dynamic version of the symbol where the value of the rotation angle α is 0° and the value of the rotation angle β is 22.5°. The challenge view of the dynamic version of the symbol includes a noisy view of the original version of the symbol superimposed on a noisy view of the dynamic version of the false symbol.

FIG. 15 (c) depicts a challenge symbol view of the dynamic version of the symbol where the value of the rotation angle α is 0° and the value of the rotation angle β is 45°. The challenge view of the dynamic version of the symbol includes a noisy view of the original version of the symbol superimposed on a noisy view of the dynamic version of the false symbol.

FIG. 15 (d) depicts a challenge symbol view of the dynamic version of the symbol where the value of the rotation angle α is 0° and the value of the rotation angle β is 67.5°. The challenge view of the dynamic version of the symbol includes a noisy view of the original version of the symbol superimposed on a noisy view of the dynamic version of the false symbol.

FIG. 15 (d) depicts a challenge symbol view of the dynamic version of the symbol where the value of the rotation angle α is 0° and the value of the rotation angle β is 90°. The symbol coordinate system is in the false symbol view orientation. The challenge view of the dynamic version of the symbol includes a noisy view of the original version of the symbol superimposed on a false symbol view of the dynamic version of the false symbol. It should be noted that while an example illustrating a manner of defining a dynamic version of a symbol including a dynamic version of an original symbol and a dynamic version of a false symbol a component has been described, alternative techniques for defining a dynamic version of a symbol including a dynamic version of an original symbol and a dynamic version of a false symbol are also considered to be within the scope of the invention. Furthermore, defining the false symbol before the original symbol is also considered to be within the scope of the invention.

When a user at the system 100 wishes to access a symbol stored in the system 100 by the challenge symbol generator 114, the user retrieves the stored challenge symbol view associated with the symbol from the memory 104. The retrieved challenge symbol view is displayed in a viewing plane. In one embodiment, the boundaries of the display screen at the system 100 define the viewing plane. In one embodiment, a selected area of the display screen is defined as the viewing plane. The user is provided with a view selection field for selecting different symbol views of the dynamic version of the symbol associated with the retrieved challenge symbol view. In one embodiment, the view selection field is defined by the boundaries of the viewing plane. In one embodiment, the view selection field is defined as a selected area of the display screen. In one embodiment, the view selection field is defined as a selected area of the viewing plane. In one embodiment, the view selection field is a component of the view selection mechanism.

The orientation of the symbol coordinate system with respect to the viewing plane associated with the retrieved challenge symbol view is designated the first orientation position. A user can selectively rotate the symbol coordinate system containing a rendering of the dynamic version of the symbol associated with the retrieved challenge symbol view from the first orientation position through a rotation angle α′ about the x-axis and a rotation angle β′ about the y-axis thereby generating the symbol view associated with the new orientation of the symbol coordinate system with respect to the viewing plane. In other words, rotating the symbol coordinate system about the x-axis and/or the y-axis yields different symbol views of the dynamic version of the symbol. In one embodiment, the symbol coordinate system is rotated a rotation angle α′ about the x-axis and/or a rotation angle β′ about the y-axis responsive to the movement of a cursor in the view selection field. In one embodiment a user-interaction script is provided at the system 100. The user-interaction script is a component of the view selection mechanism. The user-interaction script generates rotated views of a dynamic version of the symbol in the symbol coordinate system in the viewing plane responsive to input received via an input device 106. It should be noted that alternative view selection mechanisms for generating rotated views of the dynamic version of the symbol in a viewing plane are also considered to be within the scope of the invention.

In the case where the challenge symbol view generation module 208 generated the retrieved challenge symbol view by rotating the symbol coordinate system a rotation angle α₁ about the x-axis and a rotation angle β₁ about the y-axis from the initial orientation of the symbol coordinate system, the user will have to rotate the symbol coordinate system containing the retrieved challenge symbol view by a rotation angle −α₁ about the x-axis and a rotation angle −β₁ about the y-axis from the first orientation of the symbol coordinate system. In one embodiment, the challenge symbol views of the dynamic version of the symbol become increasingly similar to the original symbol view as the value of the rotation angle α ′ approaches the value of −α₁ and the value of the rotation angle β′ approaches the value of −β₁.

A human user will typically interact with or manipulate views of the dynamic version of the symbol through user input commands provided via an input device 106. The input data rotation commands received via the input device 106 are handled by an interface that translates received input data rotation commands and updates the symbol views in the viewing plane accordingly. In one embodiment, a human user will typically rotate the symbol coordinate system containing a rendering of the dynamic version of the symbol via a trial and error process until the challenge symbol views begin to approach the form of a symbol. The human user will then typically continue to rotate the symbol coordinate system in the appropriate direction to generate challenge symbol views that become increasingly similar to a symbol image until the original symbol view is displayed in the viewing plane.

In many cases, an automated agent typically approaches the analysis of symbol views of a dynamic version of the symbol at different rotation angles systematically. The automated agent also typically performs the analysis of the different symbol views using optical character recognition (OCR) technologies. OCR based analysis can often be a time consuming process. The rotation of the symbol coordinate system including a rendering of a dynamic version of a symbol may, in some cases, have the capacity to generate as many as 100,000 possible challenge symbol views on a viewing plane that are different from the original symbol view thereby creating a symbol identification challenge for an automated agent.

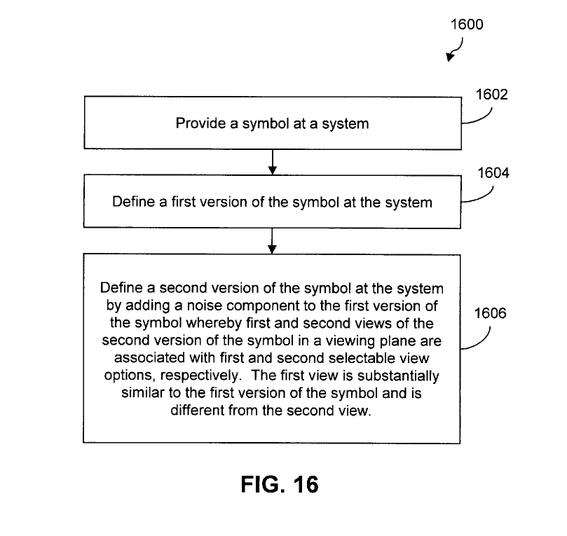

Referring to FIG. 16, a flowchart of one embodiment of a method 1600 of generating a representation of a symbol that presents a challenge for an automated agent in accordance with the principles of the present invention is shown. A symbol is provided at a first system at step 1602 and a first version of the symbol is defined at the first system at step 1604. At step 1606, a second version of the symbol is defined at the first system by adding a noise component to the first version of the symbol whereby first and second views of the second version of the symbol in a viewing plane are associated with first and second selectable view options, respectively. The first view is substantially similar to the first version of the symbol and is different from the second view. It should be noted that while the steps in the method 1600 have been described in a particular order, performing one or more of the steps in a different order are also considered to be within the scope of the invention. In one embodiment, a system 100 includes the means to perform the steps 1602-1606 described above. It should be noted that a system that performs one or more of the steps 1602-1606 in a different order are also considered to be within the scope of the invention.

In one embodiment, a machine readable medium stores a machine executable program for generating a representation of a symbol that presents an identification challenge for an automated agent. The machine readable medium includes machine readable code for providing a symbol at a first system, machine readable code for defining a first version of the symbol at the first system, and machine readable code for defining a second version of the symbol at the first system by adding a noise component to the first version of the symbol whereby first and second views of the second version of the symbol in a viewing plane are associated with first and second selectable view options, respectively, the first view being substantially similar to the first version of the symbol and different from the second view.

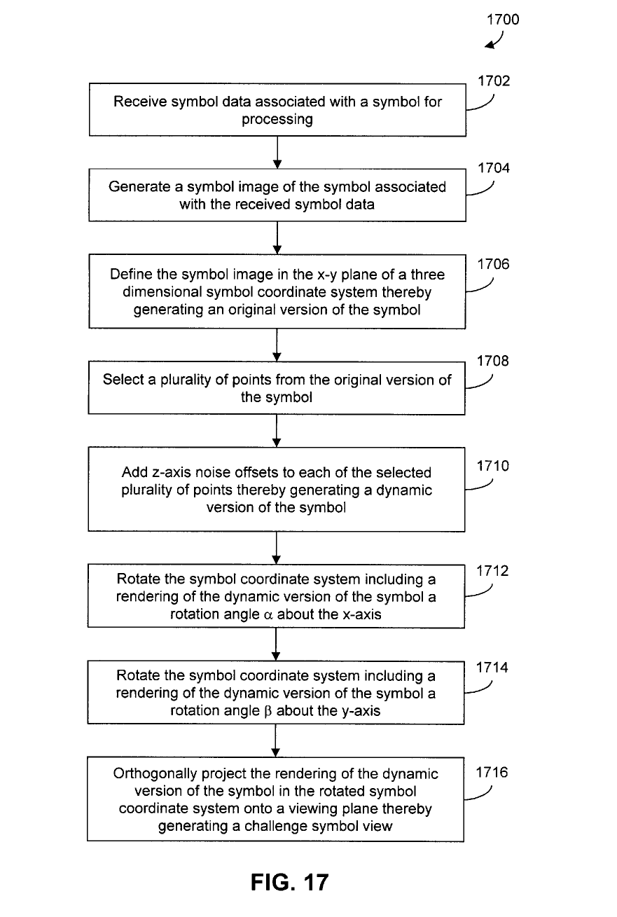

Referring to FIG. 17 a flowchart of another embodiment of a method 1700 of generating a challenge symbol view of a symbol that presents a symbol identification challenge for an automated agent in accordance with the principles of the present invention is shown. At step 1702, symbol data associated with a symbol is received at the challenge symbol generator 114. In one embodiment, the symbol data is received via an input device 106. In one embodiment, the symbol data is received via the network interface 110.

At step 1704, the symbol image generation module 202 generates a symbol image of the symbol associated with the received symbol data. In one embodiment, the symbol image is recognizable to both a human user and to an automated agent. In one embodiment, the symbol image is a distorted symbol image that is recognizable to a human user while posing a symbol identification challenge to an automated agent. At step 1706 the original symbol definition module 204 defines the symbol image in the x-y plane of a three dimensional symbol coordinate system thereby generating the original version of the symbol.

At step 1708, the dynamic symbol generation module 206 selects a plurality of points from the original version of the symbol. In one embodiment, the dynamic symbol generation module 206 selects the endpoints of the vectors defining the original version of the symbol as the plurality of points. In one embodiment, the dynamic symbol generation module 206 randomly selects the plurality of points. At step 1710, the dynamic symbol generation module 206 adds a z-axis noise offset to each of the selected plurality of points thereby generating the dynamic version of the symbol. In one embodiment, the values of each of the individual z-axis noise offsets added to each of the individual plurality of points are randomly generated values. The challenge symbol view generation module 208 rotates the symbol coordinate system including the rendering of the dynamic version of the symbol a rotation angle α about the x-axis at step 1712 and a rotation angle β about the y-axis at step 1714. In one embodiment, the value of the rotation angle α and the value of the rotation angle β are randomly generated values. At step 1716 the rendering of the dynamic version of the symbol in the rotated symbol coordinate system is orthogonally projected into a viewing plane thereby generating a challenge symbol view. In one embodiment, a challenge symbol view that is substantially different from the symbol image is selected for storage at the system 100. The symbol data and the original symbol view are then discarded so that they are not stored in the system 100. The stored challenge symbol view poses a symbol identification challenge for an automated agent that may gain access to the system 100. To gain access to the symbol, a user retrieves the challenge symbol view and rotates the symbol coordinate system containing the dynamic version of the symbol associated with the challenge symbol view about the x-axis and the y-axis until the original version of the symbol is revealed to the user. It should be noted that while the steps in the method 1700 have been described in a particular order, performing one or more of the steps in a different order are also considered to be within the scope of the invention. Furthermore, performing a subset of the steps described in the method 1700 or performing additional steps beyond those described in the method 1700 are also considered to be within the scope of the invention.

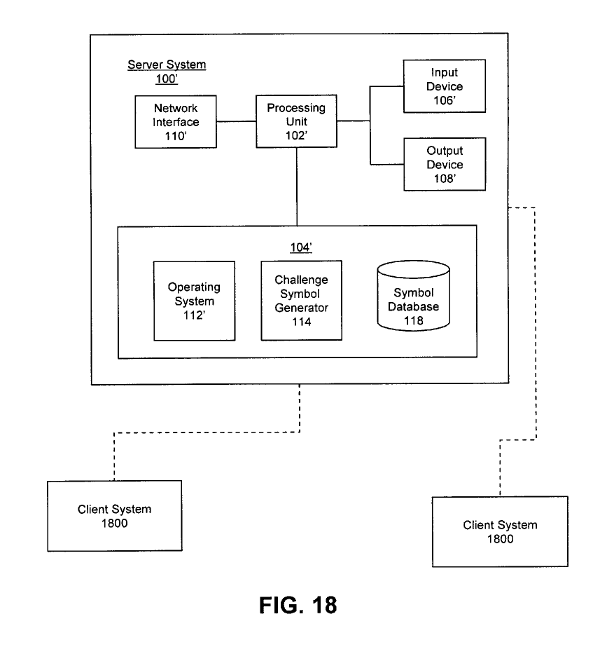

Referring to FIG. 18 a block diagram of a system 100′ that may be used to implement one embodiment of generating a representation of a symbol that presents an identification challenge for an automated agent in accordance with the principles of the present invention is shown. The system 100′ is communicatively coupled to one or more clients 1800. In one embodiment the system 100′ is a server system 100′. In one embodiment, the server 100′ is a web server system 100′. The system 100′ is communicatively coupled to one or more client systems 1800.

In one embodiment, the system 100 generally includes a processing unit 102′ communicatively coupled to a memory 104′, one or more input devices 106′, one or more output devices 106′, and a network interface 110′. In one embodiment, the network interface 110′ is an Internet interface port. In one embodiment, the memory 104 generally includes an operating system 112′, a challenge symbol generator 114′ and a symbol database 118. The processing unit 102′ generally retrieves and executes machine readable instructions or software programs that are stored in the memory 104′.

The challenge symbol generator 114 receives symbol data representative of a symbol, generates a dynamic version of the symbol associated with the received symbol data, and generates a challenge symbol view of the symbol as described above. The symbol data representative of a symbol is received at the symbol image generation module 202 of the challenge symbol generator 114. In one embodiment, the symbol data is received at the system 100′ via an input device 106′. In one embodiment, the symbol data is received at the system 100 via the network interface 110′. In one embodiment, a plurality of symbols is stored in the symbol database 118. In one embodiment, the symbol data associated with each of the plurality of symbols is stored in the symbol database 118.

In one embodiment, a challenge symbol view of a symbol is generated at the system 100′ responsive to a request for transmission of a symbol from the system 100′ to a client system 1800. The challenge symbol view of the dynamic representation of the symbol associated with the symbol is generated at the system 100′ using the challenge symbol generator 114. In one embodiment the challenge symbol view is transmitted from the system 100′ to the client system 1800. In one embodiment, a view selection mechanism is transmitted from the system 100′ to the client system 1800. In one embodiment, a copy of the dynamic version of the symbol is stored in the symbol database 118. In one embodiment, a copy of the challenge symbol view transmitted from the system 100′ to the client 180 is stored in the symbol database. In one embodiment, where the symbol data associated with the transmitted symbol is received from a source external to the system 100′, a copy of the symbol is stored in the symbol database 118. In one embodiment, symbol identification data associated with the symbol is stored in the symbol database 118.

The challenge symbol view received at the client system 1800 is displayed in a viewing plane. In one embodiment, the boundaries of a client system display screen define the viewing plane. In one embodiment, a selected area of the client system display screen is defined as the viewing plane. The user is provided with a view selection field at the client system 1800 for selecting different symbol views of the dynamic version of the symbol associated with the received challenge symbol view. In one embodiment, the view selection field is defined by the boundaries of the viewing plane. In one embodiment, the view selection field is defined as a selected area of the client system display screen. In one embodiment, the view selection field is defined as a selected area of the viewing plane. In one embodiment, the view selection field is a component of the view selection mechanism.

The orientation of the symbol coordinate system with respect to the viewing plane associated with the received challenge symbol view is designated the first orientation position. A user can selectively rotate the symbol coordinate system containing the rendering of the dynamic version of the symbol associated with the received challenge symbol view from the first orientation position through a rotation angle α ′ about the x-axis and a rotation angle β′ about the y-axis thereby generating the symbol view associated with the new orientation of the symbol coordinate system with respect to the viewing plane. In other words, rotating the symbol coordinate system about the x-axis and/or the y-axis yields different symbol views of the dynamic version of the symbol.

In one embodiment, the symbol coordinate system is rotated a rotation angle α ′ about the x-axis and/or a rotation angle β′ about the y-axis responsive to the movement of a cursor in the view selection field. In one embodiment a user-interaction script is provided at the client system 1800. The user-interaction script is a component of the view selection mechanism. The user-interaction script generates rotated views of a dynamic version of the symbol in the symbol coordinate system in the viewing plane responsive to input received via a client input device 106′. It should be noted that alternative view selection mechanisms for generating rotated views of the dynamic version of the symbol in a viewing plane are also considered to be within the scope of the invention.

In the case where the challenge symbol generator 114 generated the challenge symbol view by rotating the symbol coordinate system a rotation angle α₁ about the x-axis and a rotation angle β₁ about the y-axis from the initial orientation of the symbol coordinate system, the user will have to rotate the symbol coordinate system containing the received challenge symbol view by a rotation angle −α₁ about the x-axis and a rotation angle −β₁ about the y-axis from the first orientation of the symbol coordinate system. In one embodiment, the challenge symbol views of the dynamic version of the symbol become increasingly similar to the original symbol view as the value of the rotation angle α ′ approaches the value of −α₁ and the value of the rotation angle β′ approaches the value of −β₁.

A human user will typically interact with or manipulate views of the dynamic version of the symbol through user input commands provided via a client system input device. The input data rotation commands received via the client system input device is handled by an interface that translates received input data rotation commands and updates the symbol views in the viewing plane accordingly. In one embodiment, a human user will typically rotate the symbol coordinate system containing a rendering of the dynamic version of the symbol via a trial and error process until the challenge symbol views begin to approach the form of a symbol. The human user will then typically continue to rotate the symbol coordinate system in the appropriate direction to generate challenge symbol views that become increasingly similar to a symbol image until the original symbol view is displayed in the viewing plane.

In one embodiment, once a user at the client system 1800 identifies the symbol associated with the dynamic version of the symbol, the user transmits symbol identification data associated with the identified symbol from the client system 1800 to the system 100′. Once the system 100′ received the symbol identification data associated with the symbol originally transmitted from the system 100′ that that particular client system 1800, the processing unit 102′ retrieves a copy of the symbol identification data associated with the transmitted symbol from the symbol database 118. The processing unit 102′ compares the symbol identification data received from the client 1800 with the symbol identification data retrieved from the symbol database 118. In one embodiment, the system 100′ makes a determination that the user at the client system 1800 is a human user if the symbol identification data received at the system 100′ correctly identifies the symbol associated with the dynamic version of the symbol transmitted from the system 100′ to that client system 1800.

It should be noted that while systems implemented using software or firmware executed by hardware have been described above, those having ordinary skill in the art will readily recognize that the disclosed systems could be implemented exclusively in hardware through the use of one or more custom circuits, such as for example, application-specific integrated circuits (ASICs) or any other suitable combination of hardware and/or software.

While the embodiments of the invention disclosed herein are presently considered to be preferred, various changes, and modifications can be made without departing from the spirit and scope of the invention. The scope of the invention is indicated in the appended claims, and all changes that come within the meaning and range of equivalents are intended to be embraced therein.

1. A method of generating a representation of a symbol that presents an identification challenge for an automated agent, the method comprising:
providing a symbol at a first system;
defining a first version of the symbol at the first system; and
defining a second version of the symbol at the first system by adding a noise component to the first version of the symbol whereby first and second views of the second version of the symbol in a viewing plane are associated with first and second selectable view options, respectively, the first view being substantially similar to the first version of the symbol and different from the second view.

2. The method of claim 1, wherein defining the second version of the symbol comprises:
defining the first version of the symbol in a three dimensional symbol coordinate system defined by first, second and third axes, the first version of the symbol being defined in a first plane defined by the first and second axis, the first plane being generally parallel to the viewing plane;
selecting first and second points of the first version of the symbol; and
adding first and second noise offsets in the third axis to the selected first and second points, respectively, thereby defining the second version of the symbol.

3. The method of claim 2, further comprising:
rotating the three dimensional coordinate system a first angle about one of the first and second axes; and
defining a projection of an image of a rotated second version of the symbol within the rotated three dimensional coordinate system onto the viewing plane as the second view of the second version of the symbol.

4. The method of claim 2, further comprising:
rotating the three dimensional coordinate system a first angle about one of the first and second axes;
rotating the three dimensional coordinate system a second angle about the other one of the first and second axes; and
defining a projection of an image of a rotated second version of the symbol within the rotated symbol coordinate system onto the viewing plane as the second view of the second version of the symbol.

5. The method of claim 1, further comprising randomly generating the noise component.

6. The method of claim 1, further comprising transmitting the second view of the second version of the symbol from the first system to a second system.

7. The method of claim 6, further comprising transmitting a view selection mechanism including first and second selectable view options from the first system to the second system.

8. The method of claim 6, further comprising:
receiving the second view of the second version of the symbol from the first system at the second system;
displaying the second view of the second version of the symbol on the viewing plane on a display screen at the second system;
defining the viewing plane as a view selection mechanism wherein selection of first and second areas of the viewing plane corresponds to selection of the first and second selectable view options, respectively; and
displaying the first view of the second version of the symbol on the display screen at the second system responsive to selection of the first view option.

9. The method of claim 6, further comprising:
storing a first symbol identification data associated with the symbol at the first system;
receiving a second symbol identification data from the second system at the first system;
determining whether the second symbol identification data matches the first symbol identification data; and
identifying a user of the second system as a human user based on the determination.

10. The method of claim 1, wherein defining a first version of the symbol at the first system comprises defining a distorted image of the symbol.

11. The method of claim 1, wherein defining a second version of the symbol by adding a noise component to the first version of the symbol comprises adding a noise component that generates a false symbol view as the second view of the second version of the symbol, and the method further comprises generating an indication that the false symbol view is not a representation of the symbol.

12. A machine readable medium for storing a machine executable program for generating a representation of a symbol that presents an identification challenge for an automated agent comprising:
machine readable code for providing a symbol at a first system;
machine readable code for defining a first version of the symbol at the first system; and
machine readable code for defining a second version of the symbol at the first system by adding a noise component to the first version of the symbol whereby first and second views of the second version of the symbol in a viewing plane are associated with first and second selectable view options, respectively, the first view being substantially similar to the first version of the symbol and different from the second view.

13. The machine readable medium of claim 12, wherein the machine readable code for defining the second version of the symbol comprises:
machine readable code for defining the first version of the symbol in a three dimensional symbol coordinate system defined by first, second and third axes, the first version of the symbol being defined in a first plane defined by the first and second axis, the first plane being generally parallel to the viewing plane;
machine readable code for selecting first and second points of the first version of the symbol; and
machine readable code for adding first and second noise offsets in the third axis to the selected first and second points, respectively, thereby defining the second version of the symbol.

14. The machine readable medium of claim 13, further comprising:
machine readable code for rotating the three dimensional coordinate system a first angle about one of the first and second axes; and
machine readable code for defining a projection of an image of a rotated second version of the symbol within the rotated three dimensional coordinate system onto the viewing plane as the second view of the second version of the symbol.

15. The machine readable medium of claim 13, further comprising:
machine readable code for rotating the three dimensional coordinate system a first angle about one of the first and second axes;
machine readable code for rotating the three dimensional coordinate system a second angle about the other one of the first and second axes; and
machine readable code for defining a projection of an image of a rotated second version of the symbol within the rotated symbol coordinate system onto the viewing plane as the second view of the second version of the symbol.

16. The machine readable medium of claim 12, further comprising machine readable code for randomly generating the noise component.

17. The machine readable medium of claim 12, further comprising machine readable code for transmitting the second view of the second version of the symbol from the first system to a second system.

18. The machine readable medium of claim 17, further comprising machine readable code for transmitting a view selection mechanism including first and second selectable view options from the first system to the second system.

19. The machine readable medium of claim 17, further comprising:
machine readable code for receiving the second view of the second version of the symbol from the first system at the second system;
machine readable code for displaying the second view of the second version of the symbol on the viewing plane on a display screen at the second system;
machine readable code for defining the viewing plane as a view selection mechanism wherein selection of first and second areas of the viewing plane corresponds to selection of the first and second selectable view options, respectively; and
machine readable code for displaying the first view of the second version of the symbol on the display screen at the second system responsive to selection of the first view option.

20. The machine readable medium of claim 17, further comprising:
machine readable code for storing a first symbol identification data associated with the symbol at the first system;
machine readable code for receiving a second symbol identification data from the second system at the first system;
machine readable code for determining whether the second symbol identification data matches the first symbol identification data; and
machine readable code for identifying a user of the second system as a human user based on the determination.

21. The machine readable medium of claim 12, wherein the machine readable code for defining a first version of the symbol at the first system comprises machine readable code for defining a distorted image of the symbol.

22. The machine readable medium of 12, wherein the machine readable code for defining a second version of the symbol by adding a noise component to the first version of the symbol comprises machine readable code for adding a noise component that generates a false symbol view as the second view of the second version of the symbol, and the machine readable medium further comprises machine readable code for generating an indication that the false symbol view is not a representation of the symbol.

23. A system for generating a representation of a symbol that presents an identification challenge for an automated agent, the system comprising:
means for providing a symbol at a first system;
means for defining a first version of the symbol at the first system; and
means for defining a second version of the symbol at the first system by adding a noise component to the first version of the symbol whereby first and second views of the second version of the symbol in a viewing plane are associated with first and second selectable view options, respectively, the first view being substantially similar to the first version of the symbol and different from the second view.

24. The system of claim 23, wherein the means for defining the second version of the symbol comprises:
means for defining the first version of the symbol in a three dimensional symbol coordinate system defined by first, second and third axes, the first version of the symbol being defined in a first plane defined by the first and second axis, the first plane being generally parallel to the viewing plane;
means for selecting first and second points of the first version of the symbol; and
means for adding first and second noise offsets in the third axis to the selected first and second points, respectively, thereby defining the second version of the symbol.

25. The system of claim 24, further comprising:
means for rotating the three dimensional coordinate system a first angle about one of the first and second axes; and
means for defining a projection of an image of a rotated second version of the symbol within the rotated three dimensional coordinate system onto the viewing plane as the second view of the second version of the symbol.

26. The system of claim 24, further comprising:
means for rotating the three dimensional coordinate system a first angle about one of the first and second axes;
means for rotating the three dimensional coordinate system a second angle about the other one of the first and second axes; and
means for defining a projection of an image of a rotated second version of the symbol within the rotated symbol coordinate system onto the viewing plane as the second view of the second version of the symbol.

27. The system of claim 23, further comprising means randomly generating the noise component.

28. The system of claim 23, further comprising means for transmitting the second view of the second version of the symbol from the first system to a second system.

29. The system of claim 28, further comprising transmitting a view selection mechanism including first and second selectable view options from the first system to the second system.

30. The system of claim 28, further comprising:
means for receiving the second view of the second version of the symbol from the first system at the second system;
means for displaying the second view of the second version of the symbol on the viewing plane on a display screen at the second system;
means for defining the viewing plane as a view selection mechanism wherein selection of first and second areas of the viewing plane corresponds to selection of the first and second selectable view options, respectively; and
means for displaying the first view of the second version of the symbol on the display screen at the second system responsive to selection of the first view option.

31. The system of claim 28, further comprising:
means for storing a first symbol identification data associated with the symbol at the first system;
means for receiving a second symbol identification data from the second system at the first system;
means for determining whether the second symbol identification data matches the first symbol identification data; and
means for identifying a user of the second system as a human user based on the determination.

32. The system of claim 23, wherein the means for defining a first version of the symbol at the first system comprises means for defining a distorted image of the symbol.

33. The system of claim 23, wherein the means for defining a second version of the symbol by adding a noise component to the first version of the symbol comprises means for adding a noise component that generates a false symbol view as the second view of the second version of the symbol, and the system further comprises means for generating an indication that the false symbol view is not a representation of the symbol.
